(19) United States
(12) Patent Application Publication
(10) Pub. No.: US 2026/0210469 A1
(43) Pub. Date: Jul. 23, 2026

(54) DOUBLE PIPE FITTING

(71) Applicant: Georg Ficher Rohrleitungssysteme AG, Schaffhausen (CH)

(72) Inventors: Robert REIZ, Stühlingen (DE); Daniel Wunderle, Kreuzlingen (CH); Kresimir Pesic, Schaffhausen (CH); Hanspeter Müller, Immendingen (DE); Manuel Silva, Diessenhofen (CH); Markus Breyer, Radolfzell (DE)

(21) Appl. No.: 19/446,489

(22) Filed: Jan. 12, 2026

(30) Foreign Application Priority Data
Jan. 21, 2025 (EP) 25153038.2

(51) Int. Cl. F16L 37/091; F16L 21/06; F16L 33/18

(52) U.S. Cl. CPC F16L 37/091; F16L 21/06; F16L 33/18

(57) ABSTRACT

A method for producing a double pipe fitting, wherein the double pipe fitting has an internal, medium-conducting fitting and an external fitting, which surrounds the internal, medium-conducting fitting, the method including providing an internal fitting, machining the internal fitting by cutting off a connector, arranging the machined internal fitting in an external fitting, and attaching the cut-off connector to the machined internal fitting in the external fitting.

### CROSS-REFERENCE TO RELATED APPLICATIONS

This application claims the benefit and priority of European Patent Application No. 25153038.2 filed Jan. 21, 2025. The entire disclosure of the above application is incorporated herein by reference.

### BACKGROUND OF THE INVENTION

### Technical Field

The invention relates to a method for producing a double pipe fitting, wherein the double pipe fitting has an internal, medium-conducting fitting and an external fitting, which surrounds the internal, medium-conducting fitting.

### Discussion

Double pipe fittings are usually produced by the fitting which forms the outer shell being cut open in the centre and the internal fitting being inserted. For this purpose, however, two identical fittings are required for the outer shell since, when the fitting is cut open, the waste and loss of material during the welding operation is too great for the two halves to be joined together again to form the outer shell. As a result, the material consumption during production is thereby very high and this method can only be used cost-effectively for relatively small fittings.

EP 0 414 589 A2 discloses a double pipe fitting in which the outer shell is formed by separate half-shells, which are connected to one another, and the internal fitting is inserted prior to the two half-shells being joined together. The disadvantage here is that the individual halves have to be specifically produced for this purpose, usually by injection moulding, as a result of which this is only worthwhile for large numbers of units.

One aspect of the invention is to propose a method which is intended for producing a double pipe fitting and can be used for large dimensions and is worthwhile even for small numbers of units.

### SUMMARY

This aspect is achieved according to the invention in that the method comprises the following steps:
providing an internal fitting,
machining the internal fitting by cutting off a connector,
arranging the machined internal fitting in an external fitting,
attaching the cut-off connector to the machined internal fitting in the external fitting.

A double pipe fitting which has an internal, medium-conducting fitting and an external fitting, which surrounds the internal, medium-conducting fitting, the fittings preferably being formed from plastic, is produced by the method according to the invention, for which there is provided a fitting which serves, in the double pipe fitting, as an internal fitting. The internal fitting in the double pipe fitting, before being introduced into a surrounding fitting, is machined by a connector being cut off from the internal fitting. In the case of a T-shaped component, the central connector is preferably cut off. This allows the internal fitting to be introduced into a larger, surrounding fitting. Once the connector has been cut off, the machined internal fitting is arranged in an external fitting. The machined fitting can be introduced into the external fitting by being pushed in via a connector of the external fitting. Thereafter, the previously cut-off connector is attached to the machined internal fitting in the external fitting, at the site at which the connector was previously arranged. It is advantageous if the external fitting is in the form of a single-part injection moulding, although the external fitting may also have been welded together to form a fitting from pipeline segments and pipeline sections. The internal fitting is preferably in the form of a single-part injection moulding.

It is advantageous if the cut-off connector is welded at the cut-off site of the internal fitting. This means that the internal fitting recovers the form it had prior to being machined. In addition, the connector and the machined fitting fit precisely together, which provides for a straightforward and exact joining procedure.

It has been found to be advantageous if the connector is cut off along a predefined contour. The contour on the internal fitting preferably corresponds to the inside radius of the external fitting and runs concentrically at an offset to the centre point of the diameter of the internal fitting. The contour of the inside radius of the external fitting on the T-shaped component is preferably used for cutting off the central connector. As a result of this contour, the machined internal fitting can easily be pushed into the outer fitting since, in order to be pushed in via the connector, the internal fitting is arranged concentrically or such that it rests on the inside diameter of the outer fitting and therefore does not knock against the external fitting at any point.

A preferred embodiment has been found to be one in which, for the purpose of welding the connector on the machined internal fitting, the connector and the machined fitting are heated by means of a heating element. It is advantageous if the heating element has the contour of the parting site, as a result of which the parting sites on the machined fitting and on the connector can be heated in a precise manner since the fitting and the connector rest with an exact fit against the heating element.

It has been found to be advantageous if the connector and the machined fitting are heated synchronously. For this purpose, the heating element preferably has the parting contour on the opposite sides and can thus be arranged between the machined fitting and the connector while the two plastic parts are being heated. Once the desired temperature of the plastic parts has been reached, the heating element is removed and the machined fitting and the connector are joined together. It is advantageous if the heating element and the connector of the internal fitting are introduced via the connector of the external fitting until the heating element comes into contact with the machined fitting. In this position, the two parts are then heated.

A preferred embodiment has been found to be one in which the internal fitting is placed centrally in the external fitting by way of spacer elements. This ensures that the fittings are positioned in an exact manner in relation to one another and makes it easier for the fitting to be connected to a double pipeline.

It has been found to be advantageous if pipe pieces are welded on the connector of the internal fitting. As a result, the internal fitting projects slightly beyond the external fitting or at least the end sides of the fittings run in a planar manner, which facilitates connection in a double pipeline. It is preferable for the pipe piece already to be attached before the machined fitting is arranged in the external fitting, since better accessibility is ensured and the attached pipe pieces do not impede the introduction of the machined fitting into the external fitting. In addition, the inner fitting can be positioned and held on the pipe-piece-extended connector, without any elaborate securing device having to be fitted within the outer fitting.

Precise length adjustment by virtue of the protruding connectors being shortened is possible following connection of the inner fitting and connector of the inner fitting.

The inside diameter of the internal fitting is preferably >200 mm.

The method according to the invention is preferably used for producing double pipe fittings in the form of a T-shaped component, elbow component or angled component.

It has been found to be preferred if, for the purpose of producing double pipe fittings, use is made of an internal fitting having an outside diameter of 250 mm and an external fitting having an outside diameter of 355 mm or an internal fitting having an outside diameter of 315 mm and an external fitting having an outside diameter of 450 mm.

Further preferred embodiments have been found to involve the combination of the following dimensions:

| Internal fitting having | External fitting having |
|---|---|
| an outside diameter of: | an outside diameter of: |
| 280 mm | 355 mm |
| 315 mm | 400 mm |
| 355 mm | 450 mm |
| 400 mm | 500 mm |
| 450 mm | 560 mm |
| 500 mm | 630 mm |

All the possible designs are freely combinable with one another.

### BRIEF DESCRIPTION OF THE DRAWINGS

An exemplary embodiment of the invention will be described with reference to the figures, although the invention is not restricted just to this exemplary embodiment. In the figures:

FIGS. 1A-1J show the steps of the method according to the invention for producing a double pipe fitting in the form of a T-shaped component,

FIG. 2 shows a double pipe fitting in the form of a T-shaped component produced by the method according to the invention,

FIG. 3 shows the step of attaching the connector to an elbow component, and

FIG. 4 shows a double pipe fitting in the form of an elbow component produced by the method according to the invention.

### DESCRIPTION OF THE PREFERRED EMBODIMENTS OF THE INVENTION

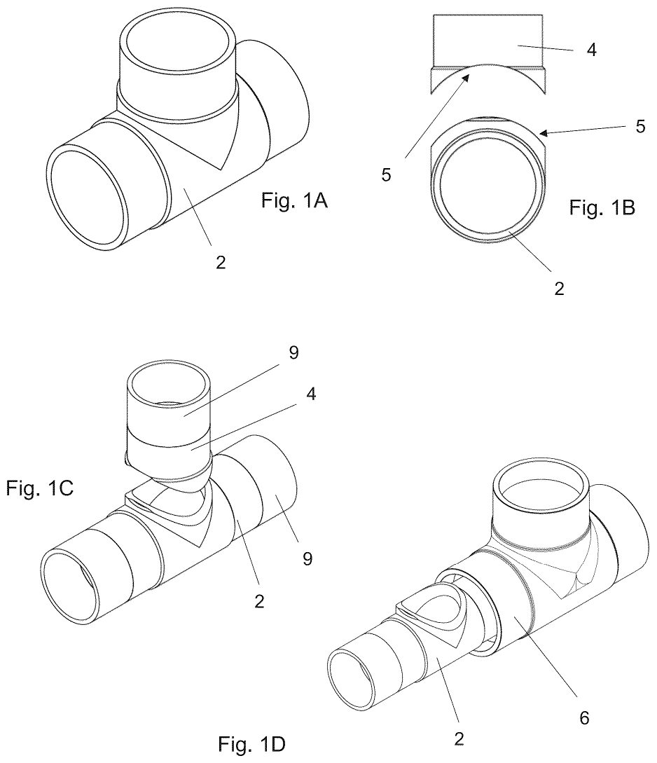

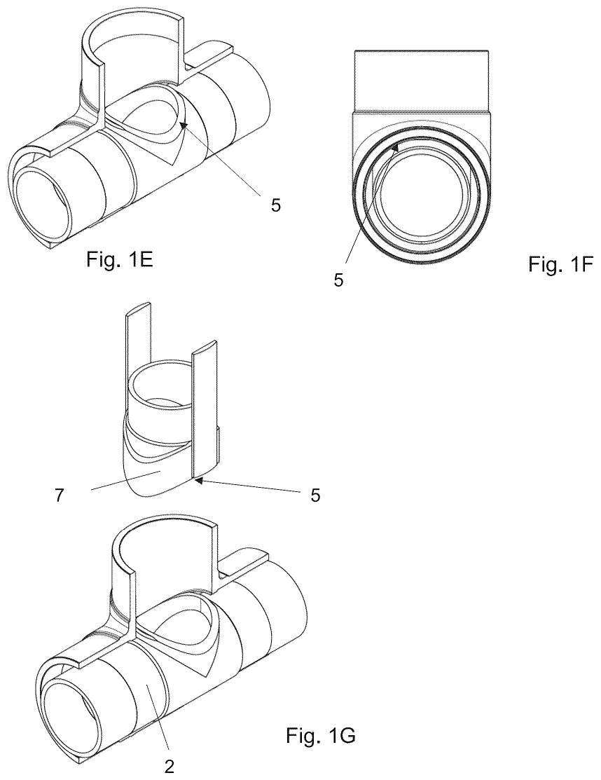

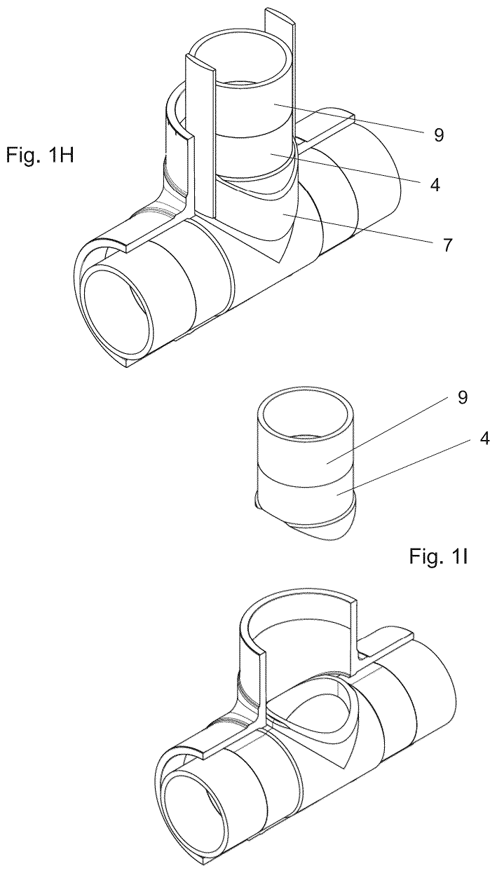

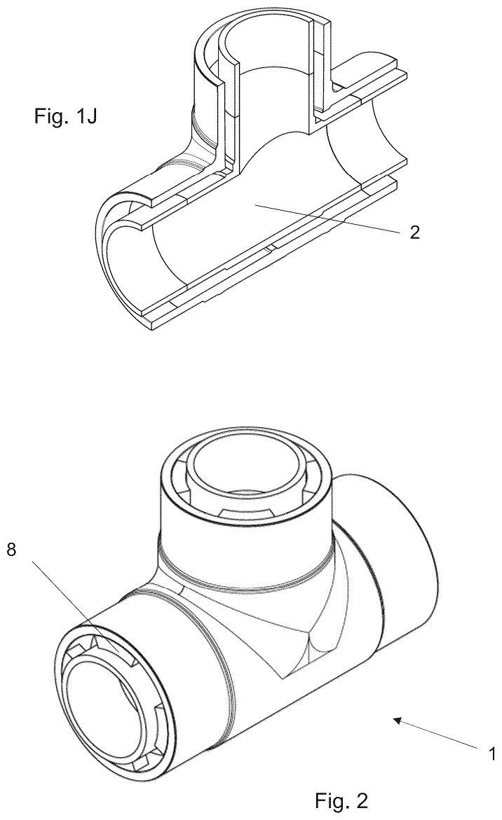

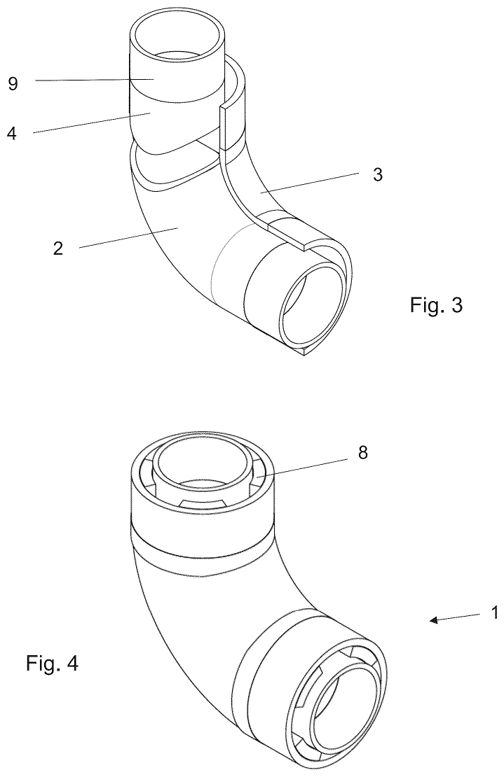

The figures illustrated in FIG. 1A-1J show the method according to the invention for producing a double pipe fitting 1 in a step-by-step manner. The double pipe fitting 1 produced by the method according to the invention has an internal, medium-conducting fitting 2 and an external fitting 3, which surrounds the internal, medium-conducting fitting 2. For the purpose of producing the double pipe fitting 1 according to the invention, an internal, medium-conducting fitting 2 is provided. The internal fitting 2 is preferably produced from plastic and is preferably in the form of a single-part injection moulding. The internal fitting 2 is then machined by a connector 4 being cut off. In the case of a T-shaped component, preferably the central connector 4 is cut off. It is advantageous if the connector 4 is cut off along a contour 5 as illustrated in FIG. 1B and FIG. 1C. The progression of the contour 5 preferably corresponds to the inside radius of the outer fitting 3, which can be seen to good effect from FIG. 1F. The machined fitting 2 is then arranged in a larger fitting 3, which forms the external fitting 3. Since the contour 5 corresponds to the progression of the inside radius of the outer fitting 3, the inner fitting 2 can avoid knocking against the outer fitting while it is being pushed in. As a result of the central connector 4 being cut off, the machined internal fitting 2 is in the form of a straight pipe with an opening and can readily be introduced or pushed in via a connector 6 of the outer fitting 3, which can be seen in FIG. 1D. The opening created in the inner fitting 2 as a result of the connector being cut off is aligned with the central connector 6 of the outer fitting 3. The cut-off connector 4 of the inner fitting 2 is introduced via the connector 6 of the outer fitting 3 and joined on the machined inner fitting 2. The cut-off connector 4 is re-attached at the position of the machined inner fitting 2 at which the connector 4 was arranged prior to being cut off. For this purpose, a heating element 7 is preferably used to heat the cut-off connector 4 and also the machined fitting 2 in the region of the opening and the cut-off contour 5 on the connector 4. For this purpose, the heating element 7, together with the connector 4 of the inner fitting 2, is advanced to the machined inner fitting 2 via the connector 6 of the outer fitting 3, which can be seen from FIG. 1G. It is advantageous if the heating element 7 heats the two parting surfaces simultaneously, which can be seen from FIG. 1H. For this purpose, the heating element 7 has, on both sides, the same contour 5 as that on the connector 4 and on the machined fitting 2. As soon as the two parting surfaces have been sufficiently heated, the heating element 7 is removed and the two heated parting surfaces are joined together, which can be seen from FIGS. 11 and 1J. In order for the inner fitting 2 to be arranged concentrically in the outer fitting 3, spacer elements 8 are arranged between the outer lateral surface of the inner fitting 2 and the inner lateral surface of the outer fitting 3, which can be gathered from FIGS. 2 and 4. It has been found to be advantageous for pipe pieces to be attached to the outer end sides of the inner fitting 2, so that the end sides of the inner fitting 2 project slightly beyond the end side of the outer fitting 3. This makes it easier for the double pipe fitting 1 to be fitted in a double pipeline, since the inner pipe is connected first of all and is more easily accessible as a result of it protruding. The pipe pieces 9 are preferably attached to the machined internal fitting 2 and to the cut-off connector 4, preferably by welding, prior to introduction into the outer fitting 3. It can clearly be seen that the pipe pieces 9 in FIG. 1B have not yet been arranged on the fitting, this only being the case in FIG. 1C et seq., where the inner fitting 2 is being introduced into the outer fitting 3.

In addition to a T-shaped component, this production method can also be used for an elbow component or angled components of a double pipe fitting 1, as can be seen from FIGS. 3 and 4. The method proceeds identically, wherein, in the case of an elbow component, it is also possible for the contour 5, for the purpose of cutting off the connector 4, to be provided in the form of a straight cut, at right angles to the centre axis of the connector 4, since the curved, internal fitting 2 can be introduced at an angle to the outer fitting 3.

1. A method for producing a double pipe fitting (1), wherein the double pipe fitting (1) has an internal, medium-conducting fitting (2) and an external fitting (3), which surrounds the internal, medium-conducting fitting (2), the method comprising:
providing an internal fitting (2),
machining the internal fitting (2) by cutting off a connector (4),
arranging the machined internal fitting (2) in an external fitting (3), and
attaching the cut-off connector (4) to the machined internal fitting (2) in the external fitting (3).

2. The method according to claim 1, wherein the cut-off connector (4) is joined at the cut-off site of the internal fitting (2).

3. The method according to claim 1, wherein the cut-off connector (4) is welded at the cut-off site of the internal fitting (2).

4. The method according to claim 1, the connector (4) is cut off along a predefined contour (5).

5. The method according to claim 4, wherein the contour (5) on the internal fitting (2) corresponds to the inside radius of the external fitting (3).

6. The method according to claim 1, wherein, for the purpose of welding the connector (4) on the machined internal fitting (2), the connector (4) and the machined fitting (2) are heated by means of a heating element (7).

7. The method according to claim 1, wherein the connector (4) and the machined fitting (2) are heated synchronously.

8. The method according to claim 1, wherein the internal fitting (2) is placed centrally in the external fitting (3) by way of spacer elements (8).

9. The method according to claim 1, pipe pieces are welded on the connector of the internal fitting.

10. The method according to claim 1, wherein the inside diameter of the internal fitting (2) is >200 mm.

11. The method according to claim 1, wherein the double pipe fitting (1) is in the form of a T-shaped component or elbow component.

12. The method according to claim 1, for the method for producing a double pipe fitting (1), use is made of an internal fitting (2) having an outside diameter of 250 mm and an external fitting (3) having an outside diameter of 355 mm or an internal fitting (2) having an outside diameter of 315 mm and an external fitting (3) having an outside diameter of 450 mm.

13. A double pipe fitting (1) produced by the method according to claim 1.
